(19) United States
(12) Patent Application Publication
(10) Pub. No.: US 2022/0059840 A1
(43) Pub. Date: Feb. 24, 2022

(54) ALL-SOLID BATTERY FOR VEHICLE

(71) Applicants: HYUNDAI MOTOR COMPANY, Seoul (KR); KIA CORPORATION, Seoul (KR)

(72) Inventors: Sang Heon LEE, Yongin-si (KR); Sang Mo KIM, Seoul (KR); Yun Sung KIM, Seoul (KR); Oh Min KWON, Nam-gu (KR); Jae Min LIM, Suwon-si (KR)

(73) Assignees: HYUNDAI MOTOR COMPANY, Seoul (KR); KIA CORPORATION, Seoul (KR)

(21) Appl. No.: 17/520,291

(22) Filed: Nov. 5, 2021

Related U.S. Application Data
(62) Division of application No. 16/179,183, filed on Nov. 2, 2018.

(30) Foreign Application Priority Data
Mar. 14, 2018 (KR) 10-2018-0029624

(51) Int. Cl. H01M 4/58; H01M 10/052; H01M 4/36; H01M 4/66

(52) U.S. Cl. CPC H01M 4/5815; H01M 10/052; H01M 2300/0094; H01M 4/664; H01M 2220/20; H01M 4/366

(57) ABSTRACT

The present disclosure provides an all-solid battery for a vehicle, which includes a cathode, a solid electrolyte layer disposed on the cathode, and an anode disposed on the solid electrolyte layer. The solid electrolyte layer includes a solid electrolyte and a ceramic which is a nonconductor.

### CROSS-REFERENCE TO RELATED APPLICATION

This application is a divisional of U.S. patent application Ser. No. 16/179,183, filed on Nov. 2, 2018, based on and claims under 35 U.S.C. § 119(a) the benefit of priority to Korean Patent Application No. 10-2018-0029624 filed on Mar. 14, 2018, the entire contents of which are incorporated herein by reference.

### TECHNICAL FIELD

The present disclosure relates to an all-solid battery for a vehicle. More particularly, it relates to an all-solid battery for a vehicle, which is stable and has a high energy density.

### BACKGROUND

Lithium secondary batteries have been developed as small-sized power sources due to the spread of smart phones and small-sized electronic devices, and demand for the lithium secondary batteries is also increasing as electric vehicles including, for example, hybrid electric vehicles, plug-in hybrid electric vehicles, all-electric vehicles, etc., are developed.

A lithium secondary battery is configured with an anode material and a cathode material which are capable of exchanging lithium ions, and an electrolyte for transporting the lithium ions. Generally, the lithium secondary battery uses a liquid electrolyte, in which lithium salt is dissolved in an organic solvent, as an electrolyte. The lithium secondary battery also uses a separator made of organic fibers so as to block a physical contact between a positive electrode and a negative electrode and prevent a short circuit. Since a combustible organic solvent is used as an electrolyte solvent, there is a high possibility of fire and explosion when a short circuit occurs due to a physical damage to the battery, and many accidents are actually occurred.

An all-solid battery is a battery in which a combustible liquid electrolyte is replaced with a solid electrolyte. However, when the all-solid battery has a high energy density at a predetermined level or more, stability of the all-solid battery is also degraded such that problems of thermal diffusion, fuming, and explosion due to heat can occur.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to solve the above-described problems associated with prior art.

In one aspect of the present disclosure an all-solid battery for a vehicle, which is stable and has a high energy density, is provided.

In a preferred embodiment, an all-solid battery for a vehicle may include a cathode, a solid electrolyte layer disposed on the cathode, and an anode disposed on the solid electrolyte layer. The solid electrolyte layer may include a solid electrolyte and a ceramic which is a nonconductor.

The solid electrolyte layer may include a first solid electrolyte layer disposed on the cathode, including the solid electrolyte, and not including the ceramic, and a composite electrolyte layer disposed on the first solid electrolyte layer and including the solid electrolyte and the ceramic.

The solid electrolyte layer may include a composite electrolyte layer disposed on the cathode and including the solid electrolyte and the ceramic, and a first solid electrolyte layer disposed on the composite electrolyte layer, including the solid electrolyte, and not including the ceramic.

The solid electrolyte layer may include a composite electrolyte layer disposed on the cathode and including the solid electrolyte and the ceramic, and a coating layer surrounding the composite electrolyte layer, including the solid electrolyte, and not including the ceramic.

The coating layer may include a lower coating layer disposed between the cathode and the composite electrolyte layer, an upper coating layer disposed between the anode and the composite electrolyte layer, a first side coating layer being in contact with one side surface of the composite electrolyte layer and connected to the lower coating layer and the upper coating layer, and a second side coating layer being in contact with another side surface of the composite electrolyte layer, being spaced apart from the first side coating layer, and connected to the lower coating layer and the upper coating layer.

A weight ratio of the solid electrolyte to the ceramic may be in the range of 0.5:1 to 5:1.

A ratio of a particle size of the solid electrolyte to a particle size of the ceramic may be in the range of 1:1 to 10:1 on a cross section.

The particle size of the solid electrolyte may be the range of 0.1 μm to 10 μm.

The particle size of the ceramic may be in the range of 0.01 μm to 5 μm.

The solid electrolyte may include at least one among Li₃—N, LISICON, LiPON, Thio-LISICON, Li₂S, Li₂S—P₂S₅, Li₂S—SiS₂, Li₂S—GeS₂, Li₂S—B₂S₅, Li₂S—Al₂S₅, and a solid argyrodite-based sulfide electrolyte.

The ceramic may include at least one among alumina, zirconium dioxide (ZrO₂), and magnesium hydroxide (Mg(OH)₂).

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present disclosure will now be described in detail with reference to certain exemplary embodiments thereof, and described in the accompanying drawings which are given hereinbelow by way of illustration only and thus are not limitative of the present disclosure:

FIG. 1 is a schematic cross-sectional view of an all-solid battery according to an embodiment of the present disclosure;

FIGS. 2A, 2B, 2C, and 2D are schematic cross-sectional views of a solid electrolyte layer included in the all-solid battery according to an embodiment of the present disclosure;

FIG. 3 is a schematic cross-sectional view of a composite electrolyte layer included in the solid electrolyte layer according to an embodiment of the present disclosure when viewed from a top;

FIG. 4A is a schematic cross-sectional view of a solid electrolyte included in the solid electrolyte layer according to an embodiment of the present disclosure; and

FIG. 4B is a schematic cross-sectional view of a ceramic included in the solid electrolyte layer according to an embodiment of the present disclosure.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

The above and other objectives, features, and advantages of the present disclosure will become more apparent from the following description of preferred embodiments with reference to the accompanying drawings. However, the present disclosure is not limited to the embodiments disclosed herein and may be implemented in other forms. The embodiments disclosed herein will be provided to make this disclosure thorough and complete, and will fully convey the spirit of the present disclosure to those skilled in the art.

In describing each drawing, similar reference numerals are assigned similar components. In the accompanying drawings, dimensions of structures are shown in an enlarged scale for clarity of the present disclosure. Although the terms “first,” “second,” and the like may be used herein to describe various components, these components should not be limited by these terms. The terms are used only for the purpose of distinguishing one component from another component. For example, without departing from the scope of the present disclosure, a first component may be referred to as a second component, and similarly, a second component may also be referred to as a first component. Unless the context clearly dictates otherwise, the singular form includes the plural form.

It should be understood that the terms “comprise,” “include,” and “have” specify the presence of stated herein features, numbers, steps, operations, components, elements, or combinations thereof, but do not preclude the presence or possibility of adding one or more other features, numbers, steps, operations, components, elements, or combinations thereof. Further, when a portion of a layer, a film, a region, a plate, or the like is referred to as being “on” other portion, this includes not only a case in which the portion is “directly on” the other portion but also a case in which another portion is present between the portion and the other portion. Contrarily, when a portion of a layer, a film, a region, a plate, or the like is referred to as being “under” other portion, this includes not only a case in which the portion is “directly under” the other portion but also a case in which another portion is present between the portion and the other portion.

An all-solid battery for a vehicle according to an embodiment of the present disclosure will be described below.

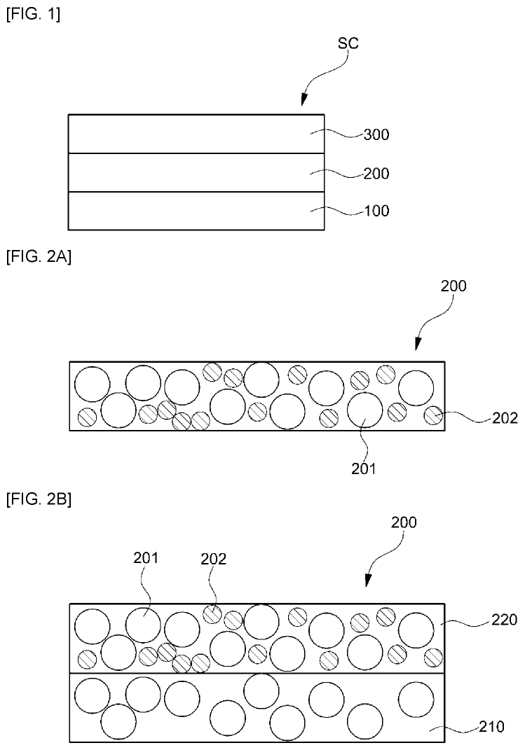

FIG. 1 is a schematic cross-sectional view of an all-solid battery according to an embodiment of the present disclosure.

Referring to FIG. 1, an all-solid battery SC may include a cathode 100, a solid electrolyte layer 200, and an anode 300. In FIG. 1, an example in which the cathode 100, the solid electrolyte layer 200, and the anode 300 have the same thickness is shown, but the present disclosure is not limited thereto. At least one of the thicknesses of the cathode 100, the solid electrolyte layer 200, and the anode 300 may be different from the remaining thicknesses thereof. For example, thicknesses of the cathode 100 and the anode 300 may be the same, whereas a thickness of the solid electrolyte layer 200 may be thicker than those of the cathode 100 and the anode 300.

An electrochemical reaction may occur in the all-solid battery SC. After hydrogen may be supplied to the anode 300, which is an oxidation electrode of the all-solid battery SC, and separated into protons and electrons, the protons move to the cathode 100, which is a deoxidation electrode, through the solid electrolyte layer 200 and the electrons move to the cathode 100 through an outer circuit. Thus, oxygen molecules, the protons, and the electrons react in the cathode 100 to generate electricity and heat. The solid electrolyte layer 200 may be disposed on the cathode 100. The solid electrolyte layer 200 may be disposed between the cathode 100 and the anode 300. The anode 300 may be disposed on the solid electrolyte layer 200. The solid electrolyte layer 200 may be in contact with each of the cathode 100 and the anode 300.

The all-solid battery SC may be used as an energy source for a vehicle. The vehicle may refer to a device for transporting goods, persons, and the like. For example, the vehicle includes a land vehicle, a water vehicle, an air vehicle. For example, the land vehicle may include automobiles, which contains passenger cars, vans, trucks, trailer trucks, and sports cars, bicycles, motorcycles, trains, and the like. For example, the water vehicle may include ships, submarines, and the like. For example, the air vehicle may include airplanes, hang-gliders, hot-air balloons, helicopters, and small-sized flight vehicles such as a drone and the like.

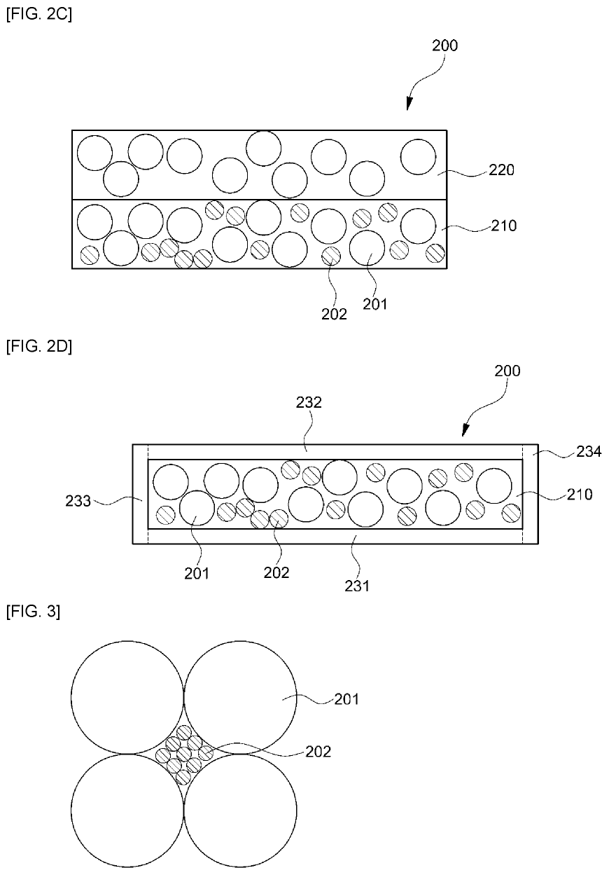

FIGS. 2A, 2B, 2C, and 2D are schematic cross-sectional views of a solid electrolyte layer included in the all-solid battery according to an embodiment of the present disclosure. In FIGS. 2B and 2C, an example in which thicknesses of a composite electrolyte layer and a first solid electrolyte layer are the same is shown, but the present disclosure is not limited thereto, and the thicknesses of the composite electrolyte layer and the first solid electrolyte layer may be different from each other. For example, a thickness of the composite electrolyte layer may be thicker than that of the first solid electrolyte layer. For example, the thickness of the composite electrolyte layer may be thinner than that of the first solid electrolyte layer.

Referring to FIGS. 2A, 2B, 2C and 2D, a solid electrolyte layer 200 includes a solid electrolyte 201 and a ceramic 202. Each of the solid electrolyte 201 and the ceramic 202 will be described below in detail.

Referring to FIG. 2A, the solid electrolyte layer 200 may be a single layer including both the solid electrolyte 201 and the ceramic 202. Referring to FIGS. 2B, 2C, and 2D, the solid electrolyte layer 200 may be configured with a plurality of layers.

Referring to FIG. 2B, the solid electrolyte layer 200 includes a first solid electrolyte layer 210 and a composite electrolyte layer 220. The first solid electrolyte layer 210 is disposed on the cathode 100. The first solid electrolyte layer 210 includes the solid electrolyte 201. The first solid electrolyte layer 210 may not include the ceramic 202.

The composite electrolyte layer 220 is disposed on the first solid electrolyte layer 210. The composite electrolyte layer 220 includes the solid electrolyte 201 and the ceramic 202.

Referring to FIG. 2C, the solid electrolyte layer 200 includes a composite electrolyte layer 210 and a first solid electrolyte layer 220. The composite electrolyte layer 210 is disposed on the cathode 100. The composite electrolyte layer 210 includes the solid electrolyte 201 and the ceramic 202. The first solid electrolyte layer 220 is disposed on the composite electrolyte layer 210. The first solid electrolyte layer 220 includes the solid electrolyte 201. The first solid electrolyte layer 220 may not include the ceramic 202.

Referring to FIG. 2D, the solid electrolyte layer 200 includes a composite electrolyte layer 210 and coating layers 231, 232, 233, and 234. In FIG. 2D, solid electrolytes contained in the coating layers 231, 232, 233, and 234 are not shown, but the coating layers 231, 232, 233, and 234 may have the same composition as that of the first solid electrolyte layer of each of FIGS. 2B and 2C. Further, an example in which a thickness of the coating layer 231, 232, 233, or 234 is thinner than that of the composite electrolyte layer 210 is shown in FIG. 2D, but the present disclosure is not limited thereto. The thickness of the coating layers 231, 232, 233, or 234 may be identical to that of the composite electrolyte layer 210. Further, the thickness of the coating layer 231, 232, 233, or 234 may be thicker than that of the composite electrolyte layer 210.

The composite electrolyte layer 210 is disposed on the cathode 100. The composite electrolyte layer 210 includes the solid electrolyte 201 and the ceramic 202.

The coating layers 231, 232, 233, and 234 surround the composite electrolyte layer 210. The coating layers 231, 232, 233, and 234 include the solid electrolyte 201. The coating layers 231, 232, 233, and 234 may not include the ceramic 202.

The coating layers 231, 232, 233, and 234 include a lower coating layer 231, an upper coating layer 232, a first side coating layer 233, and a second side coating layer 234. The lower coating layer 231 is disposed between the cathode 100 and the composite electrolyte layer 210. The upper coating layer 232 is disposed between the anode 300 and the composite electrolyte layer 210. The first side coating layer 233 is brought into contact with one side surface of the composite electrolyte layer 210. The first side coating layer 233 is connected to the lower coating layer 231 and the upper coating layer 232. The second side coating layer 234 is brought into contact with the other side surface of the composite electrolyte layer 210. The second side coating layer 234 is spaced apart from the first side coating layer 233. The second side coating layer 234 is connected to the lower coating layer 231 and the upper coating layer 232.

The solid electrolyte 201 may be an inorganic-based solid electrolyte. For example, the solid electrolyte 201 may include at least one among Li₃—N, LISICON, LiPON, Thio-LISICON, Li₂S, Li₂S-P₂S₅, Li₂S—SiS₂, Li₂S—GeS₂, Li₂S—B₂S₅, Li₂S—Al₂S₅, and a solid argyrodite-based sulfide electrolyte. The expression “A-B” may refer that each of A and B is contained in a compound and at least a part of A is chemically bonded to at least a portion of B. The term “-based” may refer to including a compound corresponding to a “-based” or a “-based” derivative. The “derivative” refers to a compound which is changed in such a manner that a structure and a property of the parent do not change such as introduction of a functional group, oxidation, reduction, substitution of an atom, and the like by a specific compound as the parent.

The ceramic 202 may be a nonconductor. The ceramic 202 may include at least one among alumina, zirconium dioxide (ZrO₂), and magnesium hydroxide (Mg(OH)₂). FIG. 3 is a schematic cross-sectional view of a composite electrolyte layer included in the solid electrolyte layer according to an embodiment of the present disclosure when viewed from a top. The expression “when viewed from a top” may refer to view in a direction from the anode 300 of FIG. 1 to the cathode 100 of FIG. 1, which is perpendicular to the ground.

For example, referring to FIG. 3, when viewed from a top, nine ceramics 202 may be disposed adjacent to one another between four adjacent solid electrolytes 201. However, this shows an exemplary arrangement relationship, and the solid electrolyte 201 and the ceramic 202 may be disposed at various positions in the composite electrolyte layer.

Referring to FIGS. 1 and 3, a weight ratio of the solid electrolyte 201 to the ceramic 202 may be in the range of 0.5:1 to 5:1. The weight may refer to a load. When the weight ratio of the solid electrolyte 201 to the weight of the ceramic 202 is less than 0.5:1 and penetration or a short circuit occurs in the all-solid battery SC, an effect of preventing heat diffusion may be degraded and thus a stability improvement effect may be insignificant. On the other hand, when the weight ratio of the solid electrolyte 201 to the weight of the ceramic 202 exceeds 5:1, ion conductivity of the solid electrolyte layer 200 is lowered and thus a charge and discharge capacity of the all-solid battery SC may be degraded.

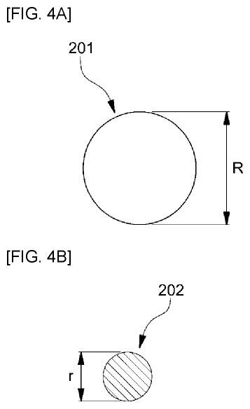

FIG. 4A is a schematic cross-sectional view of a solid electrolyte included in the solid electrolyte layer according to an embodiment of the present disclosure. FIG. 4B is a schematic cross-sectional view of a ceramic included in the solid electrolyte layer according to an embodiment of the present disclosure.

Referring to FIGS. 4A and 4B, it can be seen that a ratio of a particle size R of the solid electrolyte 201 to a particle size r of the ceramic 202 is in the range of 1:1 to 10:1 on a cross section. When the ratio of the particle size R of the solid electrolyte 201 to the particle size r of the ceramic 202 is less than 1:1, an effect of preventing heat diffusion may be degraded and thus a stability improvement effect may be insignificant. When the ratio exceeds 10:1, ion conductivity of the solid electrolyte layer 200 is lowered and thus performance of the all-solid battery SC may be degraded.

The particle size R of the solid electrolyte 201 may be in the range of 0.1 to 10 μm. For example, the particle size R of the solid electrolyte 201 may be measured by an average particle diameter D50. When the particle size R of the solid electrolyte 201 is less than 0.1 μm, slurry production and uniform cell performance are difficult to achieve, and when the particle size R of the solid electrolyte 201 exceeds 10 μm, a porosity of the mixture increases and thus ion conductivity may be degraded, and cell performance may also be degraded.

The particle size r of the ceramic 202 may be in the range of 0.01 to 5 μm. For example, the particle size r of the ceramic 202 may be measured by an average particle diameter D50. When the particle size r of the ceramic 202 is less than 0.01 μm, slurry production and uniform distribution of slurry are difficult to achieve and thus a safety improvement effect may be insignificant, and when the particle size r of the ceramic 202 exceeds 5 μm, a filling rate in the solid electrolyte layer is lowered and thus ion conductivity may be degraded.

Unlike a conventional all-solid battery, the all-solid battery according to an embodiment of the present disclosure includes the ceramic in the solid electrolyte layer to have high ion conductivity, such that the all-solid battery is excellent in stability while having a high energy density. Therefore, the all-solid battery according to an embodiment of the present disclosure is suitable for use as an energy source of a vehicle.

In accordance with an embodiment of the present disclosure, the all-solid battery for a vehicle, which is stable while having a high energy density, can be provided.

While the embodiments of the present disclosure have been described with reference to the accompanying drawings, those skilled in the art can understand that the present disclosure can be implemented in other specific forms without departing from the technical spirit or the necessary features of the present disclosure. Therefore, it should be understood that the above-described embodiments are not restrictive but illustrative in all aspects.

What is claimed is:

1. An all-solid battery for a vehicle, comprising:
a cathode;
a solid electrolyte layer disposed on the cathode; and
an anode disposed on the solid electrolyte layer,
wherein the solid electrolyte layer comprises:
a solid electrolyte; and
a ceramic which is a nonconductor, wherein the solid electrolyte layer comprises:
a composite electrolyte layer disposed on the cathode and including the solid electrolyte and the ceramic; and
a coating layer surrounding the composite electrolyte layer, including the solid electrolyte, and not including the ceramic.

2. The all-solid battery of claim 1, wherein the coating layer comprises:
a lower coating layer disposed between the cathode and the composite electrolyte layer;
an upper coating layer disposed between the anode and the composite electrolyte layer;
a first side coating layer being in contact with one side surface of the composite electrolyte layer and connected to the lower coating layer and the upper coating layer; and
a second side coating layer being contact with another side surface of the composite electrolyte layer, being spaced apart from the first side coating layer, and connected to the lower coating layer and the upper coating layer.
